(19) United States
(12) Patent Application Publication
(10) Pub. No.: US 2013/0176337 A1
(43) Pub. Date: Jul. 11, 2013

(54) Device and Method For Information Processing

(71) Applicant: Youlong Lu, Beijing (CN)

(72) Inventor: Youlong Lu, Beijing (CN)

(73) Assignees: LENOVO (BEIJING) CO., LTD., Beijing (CN); BEIJING LENOVO SOFTWARE LTD., Haidian District, Beijing (CN)

(21) Appl. No.: 13/824,846

(22) PCT Filed: Sep. 26, 2011
(86) PCT No.: PCT/CN2011/080181

§ 371 Date: Mar. 18, 2013

(30) Foreign Application Priority Data
Sep. 30, 2010 (CN) CN 201010501978.8

(51) Int. Cl. G06T 19/00

(52) U.S. Cl. CPC G06T 19/006
USPC 345/633

(57) ABSTRACT

A device and method for information processing are described. The device includes a display unit having a preset transmittance; an object determination unit configured to determine at least one object at the information processing device side; an additional information acquisition unit configured to acquire additional information corresponding to the at least one object; an additional information position determination unit configured to determine the display position of the additional information on the display unit; and a display processing unit configured to display the additional information on the display unit based on the display position.

The present invention relates to an information processing device and an information processing method, and more particularly, the present invention relates to an information processing device and an information processing method based on the virtual reality technology.

### BACKGROUND

With increasingly improvements of mobile internet services and applications, the augmented reality technology (technology of superimposing data on the real scene/object) of information processing devices, such as mobile phones or pad computers, is becoming a hotspot. For example, in the prior art, cameras on information processing devices are usually used to collect images. The objects in the captured images are identified and the data corresponding to the objects are superimposed on the display screen of the information processing device, so that augmented reality technology is implemented on the screen of the information processing device.

However, the information processing device in the prior art still has the following defects:

1. The screen of the information processing device display needs to display the images captured by the camera in real time, which greatly increases the power consumption of the information processing device, resulting in a poor endurance of information processing device.

2. The information processing device needs to dynamically superimpose and display the images captured by the camera and object data, resulting in a large consumption of system resources.

3. Because the screen resolution and the screen size of the information processing device are usually limited, their capabilities of rendering the details of the real scene are poor.

### SUMMARY

In order to address the above-mentioned problems in the prior art, according to one aspect of the present invention, an information processing device is provided, comprising: a display unit having a predetermined transmittance; an object determining unit, configured to determine at least one object on one side of the information processing device; an additional information acquisition unit, configured to acquire the additional information corresponding to the at least one object; an additional information position determining unit, configured to determine the display position of the additional information on the display unit; and a display processing unit, configured to display the additional information on the display unit based on the display position.

Further, according to another aspect of the present invention, an information processing method applied to an information processing device is provided, wherein the information processing device comprises a display unit having a predetermined transmittance. The information processing method comprises: determining at least one object on one side of the information processing device; acquiring the additional information corresponding to the at least one object; determining the display position of the additional information on the display unit; displaying the additional information on the display unit based on the display position.

With the above configuration, the display unit of the information processing device has a predetermined transmittance, so the user using the information processing device can see the scene of the real environment through the display unit. Since the user can see the scene of the real environment through the display unit, while reducing the power consumption of information processing device so as enhance the endurance of information processing device, the user can also see the high-resolution real scene. Further, the information processing device can determine the range of the real scene that the user can see through the display unit and at least one object within the range, acquire the additional information corresponding to the at least one object and display the additional information corresponding to the at least one object in the display position corresponding to the object on the display unit. Therefore, while the user sees the real scene through the display unit, the additional information is superimposed onto the display position corresponding to the object seen through the display unit, thus achieving the effect of augmented reality.

### BRIEF DESCRIPTION OF THE DRAWINGS

FIG. 1 is a block diagram illustrating the structure of the information processing device according to an embodiment of the present invention;

FIG. 2 is a block diagram illustrating the structure of the information processing device according to another embodiment of the present invention;

FIG. 3 is a schematic diagram illustrating the change of the display position of the additional information to be superimposed due to the change in position of the user's head; and

FIG. 4 is a flowchart illustrating the information processing method according to an embodiment of the present invention.

### DETAILED DESCRIPTION

Each embodiment according to the present invention will be described in detail with reference to the drawings. Herein, it should be noted that, in the drawings, the same reference numbers are given to the parts with substantially the same or similar structures and functions, and their repeated descriptions will be omitted.

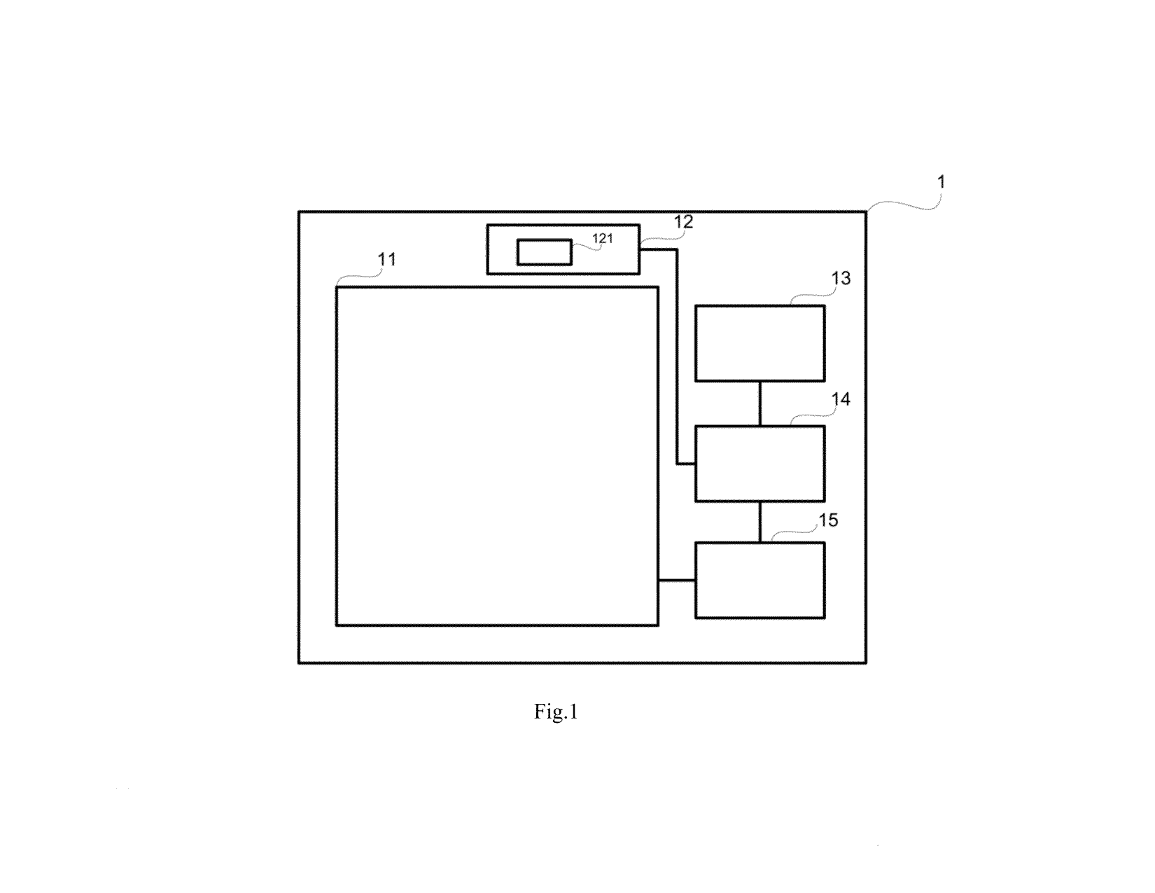

Hereinafter, the information processing device according to an exemplary embodiment of the present invention will be described. FIG. 1 is a block diagram of the structure of the information processing device 1 according to an exemplary embodiment of the present invention.

As shown in FIG. 1, according to one embodiment of the present invention, the information processing device 1 comprises a display screen 11, an object determining unit 12, an additional information acquisition unit 13, an additional information position determining unit 14 and a display processing unit 15, wherein the display screen 11 is connected to the display processing unit 15, and the object determining unit 12, the additional information acquisition unit 13, and the display processing unit 15 are connected to the additional information position determining unit 14.

The display screen 11 can comprise a display screen having a predetermined transmittance. For example, the display screen 11 can comprise two transparent components (e.g., glass, plastic, etc.) and a transparent liquid crystal layer (e.g., a monochrome liquid crystal layer) sandwiched between the transparent components. Further, for example, the display screen 11 can also comprise a transparent component, and a transparent liquid crystal layer set on one side of the transparent component (which comprises a protective film for protecting the transparent liquid crystal layer). Since the transparent component and the transparent liquid crystal layer have a predetermined transmittance, the user using the information processing device 1 can see the real scene through the display screen 11, wherein the real scene seen by the user through the display screen 11 can comprise at least one object (such as, a desk, a cup or a mouse and the like). However, the present invention is not limited thereto, any transparent display screen in the prior art and the transparent display screen that can occur in the future can be used.

The object determining unit 12 is used for determining the object on one side (i.e., the side towards the object) of the information processing device 1. For example, according to one embodiment of the present invention, the object determining unit 12 can comprise a camera module 121 provided on one side (i.e., the side towards the object) of the information processing device 1 for collecting the image on the one side of the information processing device 1. For example, the camera module 121 can be provided on top of the display screen 11 or other positions. When the user holds the information processing device 1 to view the object, the camera module 121 collects the image of the object. In addition, since the way the user holds the information processing device 1 when viewing the object and the relative position of the user and the information processing device 1 is generally fixed (e.g., the user's head is projected to the center of the display screen 11 and there is a predetermined distance from the display screen 11), and since the range (angle) of the real scene seen by the user through the display screen 11 is limited by the size of the transparent display screen 11, the focal length of the camera module 121 can be suitably selected, so that the image acquired by the camera module 121 is basically consistent with the range (angle) of the real scene seen by the user through the display screen 11.

The additional information acquisition unit 13 is used for acquiring the additional information corresponding to objects in the images captured by the image module 121. According to one embodiment of the present invention, the additional information acquisition unit 13 can comprise an image recognition unit 131. The image recognition unit 131 is used to judge the object by performing image recognition on the object in the image captured by the camera module 121 and generates the additional information relating to the class of the object. In addition, according to another embodiment of the present invention, in the case where the object (e.g. a keyboard, a mouse and the like) in the image to be captured by the camera module 121 has an electronic label and further information of the object is required to be provided, the additional information acquisition unit 13 can also comprise an electronic label recognition unit 132. The electronic label recognition unit 132 is used to recognize the object having the electronic label to judge the object and generates the additional information corresponding to the electronic label.

The additional information position determining unit 14 can determine the display position of the additional information corresponding to the object on the display screen 11.

Further, the display processing unit 15 can display additional information on the display screen 11 based on the display position determined by the additional information position unit 14.

Hereinafter, the operations performed by the information processing device 1 shown in FIG. 1 will be described.

When the user is viewing an object by using the information processing device 1, the camera module 121 of the object determining unit 12 captures the object on one side (i.e., the side towards the object) of the information processing device 1.

Then, the image recognition unit 131 of the additional information acquisition unit 13 can judge the object by performing image recognition on the object in the image captured by the camera module 121 and generate the additional information relating to the class of the object. For example, in the case where the user uses the information processing device 1 to view a cup, the image recognition unit 131 performs image recognition on the cup in the image captured by the camera module 121 and generates additional information “cup”.

Furthermore, in the case where the object in the image captured by the camera module 121 has an electronic label, the electronic label recognition module 132 of the additional information acquisition unit 13 performs recognition on the object (e.g., a mouse and the like) having an electronic label and generates additional information corresponding to the object (e.g., the model of the mouse).

In addition, if there are multiple objects in the image captured by the camera module 121, the image recognition unit 131 and/or the electronic label recognition module 132 of the additional information acquisition unit 13 recognizes the multiple objects in the image captured by the camera module 121 respectively. Here, it should be noted that, since the image recognition and the electronic label recognition are known for those skilled in the art, a detailed description thereof is omitted herein.

After the additional information acquisition unit 13 generates the additional information of the object, the additional information position determining unit 14 determines the display position of the additional information corresponding to object on the display screen 11 based on the position of the object in the image captured by the camera module 121. For example, according to one embodiment of the present invention, as described above, the focal length of the camera module 121 can be suitably selected, so that the image captured by the camera module 121 is substantially consistent with the range (viewing angle) of the real scene seen by the user through the display screen 11, that is, the images captured by the camera module 121 is substantially identical with the real scene seen by the user through the display screen 11. In this case, the additional information position determining unit 14 can determine the display position of the additional information corresponding to the object based on the position of the object in images captured by the camera module 121. For example, since the size and position of the object in the image captured by the camera module 121 corresponds to the size and position of the object seen by the user through the display screen 11, the additional information determining unit 14 can easily determine the display position of the additional information corresponding to the object on the display screen 11. For example, it is possible to determine the position corresponding to the center of the object on the screen 11 as the display position of the additional information acquired by the display additional information acquisition unit 13.

Then, the display processing unit 15 displays the additional information corresponding to the object on the display screen 11 based on the display position determined by the additional information position determination unit 14

Further, the present invention is not limited thereto. Since the camera module 121 is typically provided on top of the display screen 11, the size and position of the object in the image captured in the camera module 121 can be slightly different from those in the real scene seen by the user through the display screen 11. For example, since the camera module 121 is typically provided on top of the display screen 11, the object position in the captured image is slightly lower than the object position of the real scene seen by the user on the display. Therefore, the additional information position determining unit 14 can slightly move upwards the determined display position to correct the display position with respect to the determined display position of the additional information based on the position of the object in the image acquired by the camera module 121, so that while the user sees the real scene through the display screen 11, the additional information corresponding to the object seen by the user can be displayed in a more accurate position.

With the above configuration, since the display screen 11 has a predetermined transmittance, the user can see the scene of the real environment through the display screen 11. Therefore, when the user sees the high-resolution real scene, the power consumption of information processing device can be reduced to enhance the endurance ability of information processing device. Further, the information processing device 1 can determine the range of the real scene and the objects in the range that the user can see through the display screen 11, acquire the additional information corresponding to the object and display the additional information in the display position corresponding to the object on the display screen. Therefore, when the user sees the real scene through the display screen, the additional information is superimposed in the display position corresponding to the object on the display screen, thus achieving the effect of augmented reality.

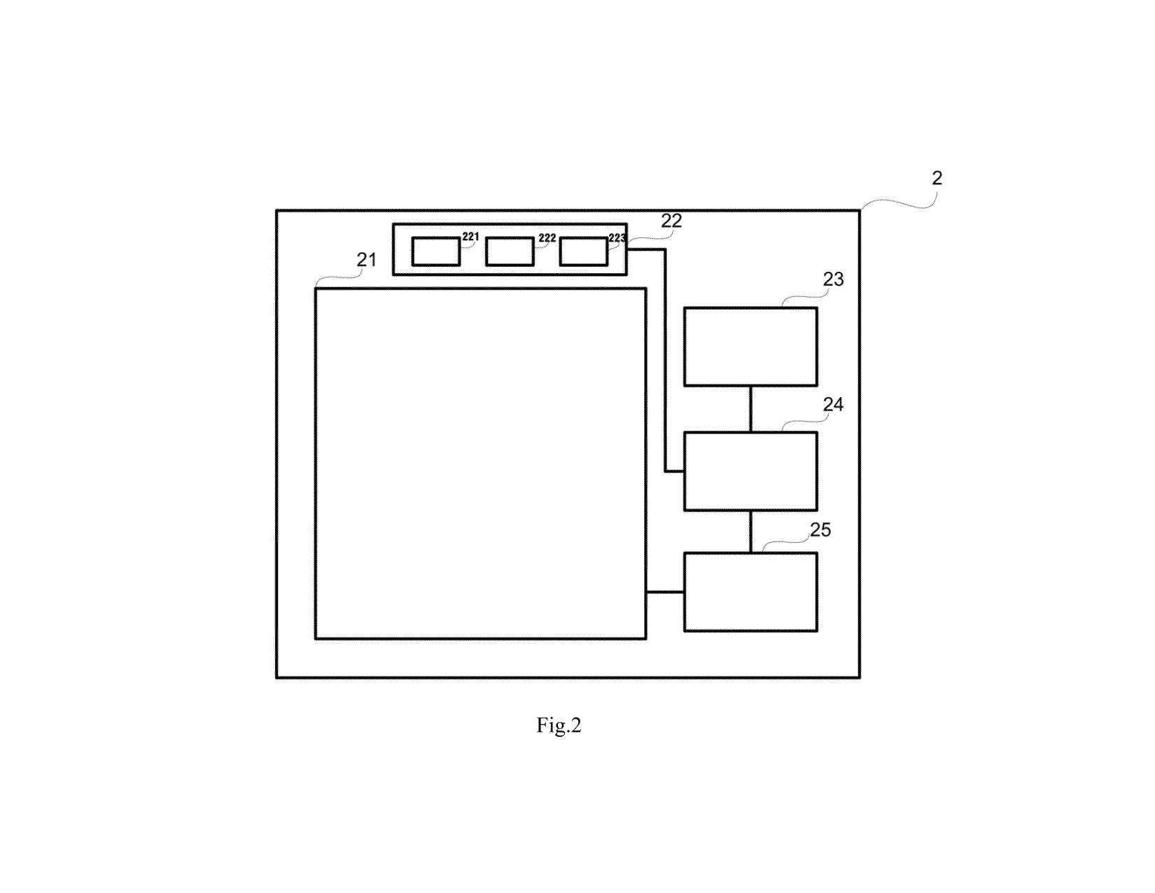

Hereinafter, the structure and operation of the information processing device of another embodiment according to the present invention will be described. FIG. 2 is a block diagram illustrating the structure of the information processing device 2 according to an embodiment of the present invention.

As shown in FIG. 2, the information processing device 2 comprises a display screen 21, an object determining unit 22, an additional information acquisition unit 23, an additional information position determining unit 24 and a display processing unit 25, wherein the display screen 21 and the display processing unit 25 are connected, and the object determining unit 22, the additional information acquisition unit 23 and the display processing unit 25 are connected with the additional information position determining unit 24.

Different from the information processing device 1 shown in FIG. 1, the object determining unit 22 of the information processing device 2 further comprises a positioning module 221, a direction detecting module 222, and an object determining module 223, and the additional information position determining unit 24 further comprises an object position acquisition module 241. Since the display screen 21 and the display processing unit 25 of the information processing device 2 is the same with the structure and function of the corresponding parts of the information processing device 1 of FIG. 1, a detailed description thereof is thus omitted.

According to the present embodiment, the positioning module 221 is used to acquire the current position data (e.g., coordinate data) of the information processing device 2, and can be a positioning unit such as a GPS module. The direction detecting module 222 is used for acquiring the orientation data of the information processing device 2 (i.e., the display screen 21), and can be a direction sensor such as a geomagnetic sensor or the like. Object determining module 223 is used to determine the object range seen by the user using the information processing device 2 based on the current position data and orientation of the data information processing device 2, and can determine at least one object within the object range satisfying a predetermined condition. Here, it should be noted that the object range refers to the observation (visual) range (viewing angle) of the scene seen by the user through the display screen 21 of the information processing device 2. Moreover, the object position acquisition module 241 is used for acquiring the position data corresponding to the at least one object, and can comprise a three-dimensional camera module, a distance sensor or a GPS module etc.

The operations performed by the information processing device 2 when the user uses the information processing device 2 to see the real scene will be described below. Here, it should be noted that since the way the user holds the information processing device 1 when viewing the object and the relative position of the user and the information processing device 1 is generally fixed, for example, the head projection of the user is usually in the center of the information processing device 21 and there is a predetermined distance (e.g., 50 cm) from the display screen 11, in the present embodiment and in the default case, the information processing device 2 performs the determination operation of the display position of the additional information based on the case where the user's head corresponds to the central position of the display screen 21, and there is a predetermined distance to the display the screen 11 (e.g., 50 cm).

When the user uses the information processing device 2 to see the real scene, the positioning module 221 acquires the current position data (e.g., longitude and latitude data, altitude data, etc.) of the information processing device 2. The Direction detecting module 222 acquires the orientation data of the information processing device 2. The object determining module 223 determines where the information processing device 2 (user) is and which direction the user is looking towards based on the current position data and orientation data of the information processing device 2.

Further, since in the default case, the user's head corresponds to the central position of the display screen 21 and there is a predetermined distance to the display screen 2, after the position and orientation of the information processing device 2 is determined, the visual range (i.e., viewing angle) of the scene (such as a building, a landscape, etc.) seen by the user through the display screen 21 of the information processing device 2 can be determined by using trigonometric functions (such as the ratio of the size of the display screen 21 to the distance between the user's and the display screen 21, etc.) based on the distance from the user's head to the display screen 21 and the size of the display screen 21.

After determining the visual range (i.e., viewing angle) of the scene (e.g., buildings, landscapes, etc.) seen by the user through the display screen 21 of the information processing device 2, the object determining module 223 can determine at least one object within the visual range based on a predetermined condition. For example, the predetermined condition can be an object within one kilometer to the information processing device 2, or an object of a certain type in the visual range (e.g., a building) etc. Here, the object determining module 223 can implement the determination process by searching objects satisfying predetermined condition (e.g., distance, the object type, etc.) in the map data stored in the storage device (not shown) of the information processing device 2 or the map data stored in the map server connected with the information processing device 2.

After the object determining module 223 determines at least one object within the visual range based on a predetermined condition, the additional information acquisition unit 23 can acquire the additional information corresponding to the determined object (eg, building names, stores in the buildings, etc.) from the map data stored in the storage device (not shown) of the information processing device 2 or the map data stored in the map server connected with the information processing device 2.

After the additional information acquisition unit 23 acquires the additional information corresponding to the object, the object position acquisition module 241 acquires the position of the object. In this case, the additional information position determining unit 24 determines the display position of the additional information on the display screen 21 based on the determined visual range and the position of the object.

Specifically, in the case where the object position acquisition module 241 acquires the position of the object using the GPS module, the object position acquisition module 241 can acquire the coordinate data (e.g., longitude and latitude data, altitude data, etc.) of the object through the map data. Further, since the coordinate data of the user is almost the same with the coordinate data of the information processing device 2, the object position acquisition module 241 can also acquire the distance between the object and the information processing device 2 (user) through the difference between the coordinate data of the object and the coordinate data of the information processing device 2 (user). Further, the object position acquisition module 241 can also acquire the connecting direction from the processing device 2 (user) to the object and acquire the angle between the object and the direction of the information processing device 2 through the acquired connecting direction and the orientation data of the information processing device 2.

Further, the object position acquisition module 241 can also acquire the distance between the object and the information process device 23 (user) and the angle between the object and the orientation of the information processing device 2 by using a three-dimensional (3D) camera module, and acquire the position (e.g., latitude, longitude and altitude data) of the object based on the coordinates of the information processing device 2, the distance between the object and the information processing device 2 (user) and the angle between the object and the information processing device 2. Since the content on acquiring the distance the between the object and the information processing device 2 (user) as well as the angle between the object and the information processing device 2 using the 3D camera module 2 is well known for those skilled in the art, detailed description thereof is omitted. Further, description for the 3D camera technology can also be acquired with reference to http://www.Gesturetek.com/3ddepth/introduction.php and http://www.en.wikipedia org/wiki/Range_imaging.

Further, the object position acquisition module 241 can also use a distance sensor to determine the distance between the object and the information processing device 2 (user) and the angle between the object and the information processing device 2. For example, a distance sensor can be the infrared emitting means or ultrasonic emitting means having a multi-direction emitter. The distance sensor can determine the distance between the object and the information processing device 2 (user) as well as the angle between the object and the information processing device 2 through the time difference of signal emission and return in each direction, the speed of the emitted signal (e.g., infrared or ultrasonic) and the direction thereof. Moreover, the object position acquiring module 241 can also acquire the position of the object (e.g., latitude and longitude and altitude data) based on the coordinates of the information processing device 2, the distance between the object and the information processing device 2 and the angle between the object and the information processing device 2. Since the above content is well known for the skilled in the art, a detailed description thereof is thus omitted herein.

After the distance between the object and the information processing device 2 (user) and the angle between the object and the orientation of the information processing device 2 are determined, the additional information processing device 24 can calculate the projection distance from the object to the plane where the display screen 21 of the information processing device 21 is. After determining the projection distance from the object to the plane where the display screen 21 of the information processing device 2 is, the additional information position determining unit 24 uses the data of the current position and the orientation of the information processing device 2, the projection distance from the object to the information processing device 2 (the display screen 21) and the visual range (viewing angle) previously acquired to construct a virtual plane. Since a virtual plane is constructed through the projection distance from the object to the information processing device 2 (the display screen 21) and, as described above, the object is the object determined in the visual range, the position of the object is in the virtual plane constructed by the additional information position determining unit 24. Here, it should be noted that the virtual plane represents the maximum range of the scene that the user can see through the display screen 21 at the projection distance from the object to the information processing device 2. Here, since the current position, orientation of the information processing device 2, and the projection distance from the object to the information processing device 2 and the visual range are known, the additional information position determining unit 24 can calculate the coordinates (e.g., latitude, longitude and altitude information, etc.) of the four vertices of the virtual plane as well as the side length of the virtual plane using the trigonometric function based on the above-described information.

After constructing the virtual plane, the additional information position determining unit 24 determines the position of the object in the virtual plane constructed for the object. For example, the position of the object in the virtual plane can be determined through the distance from the object to the four vertices of the virtual plane. In addition, the position of the object in the virtual plane can be determined through the distance from the object to the four sides of the virtual plane.

After determining the position of the object in the virtual plane, the additional information position determining unit 24 can determine the display position of the additional information on the display screen 21. For example, the additional information position determining unit 24 can set the display position of the additional information based on the ratio of the distance between the object and the four vertices of the virtual plane to the side length of the virtual plane or the ratio of the distance between the object and the four sides of the virtual plane to the side length. In addition, if there are multiple objects in the visual range of the user, the additional information position determining unit 24 repeats the above processing until the position of the additional information of all objects are determined.

Then, the display processing unit 25 displays the additional information of the object in the position corresponding to the object on the display screen 21 based on the display position of the additional information determined by the additional information position determining unit 24.

The display position of the additional information is set in the above manner, so that the additional information displayed on the display screen 21 corresponding to the object coincides with the position of the object through the display screen 21, therefore the user can directly see which object's additional information the additional information is.

With the above configuration, since the user can see the scene of the real environment through the display screen 21, while the user sees the real scene of high resolution, the power consumption of the information processing device 2 can be reduced so as to enhance the endurance of the information processing device. Furthermore, the information processing device 2 can also determine the range of the real scene that the user can see through the display screen 21 and the objects within this range, acquire the additional information corresponding to the object and display the additional information in the position corresponding to the object on the display screen. Therefore, while the user sees the real scene through the display screen, the additional information is superimposed on the display position on the display screen corresponding to the object, thus achieving the effect of augmented reality.

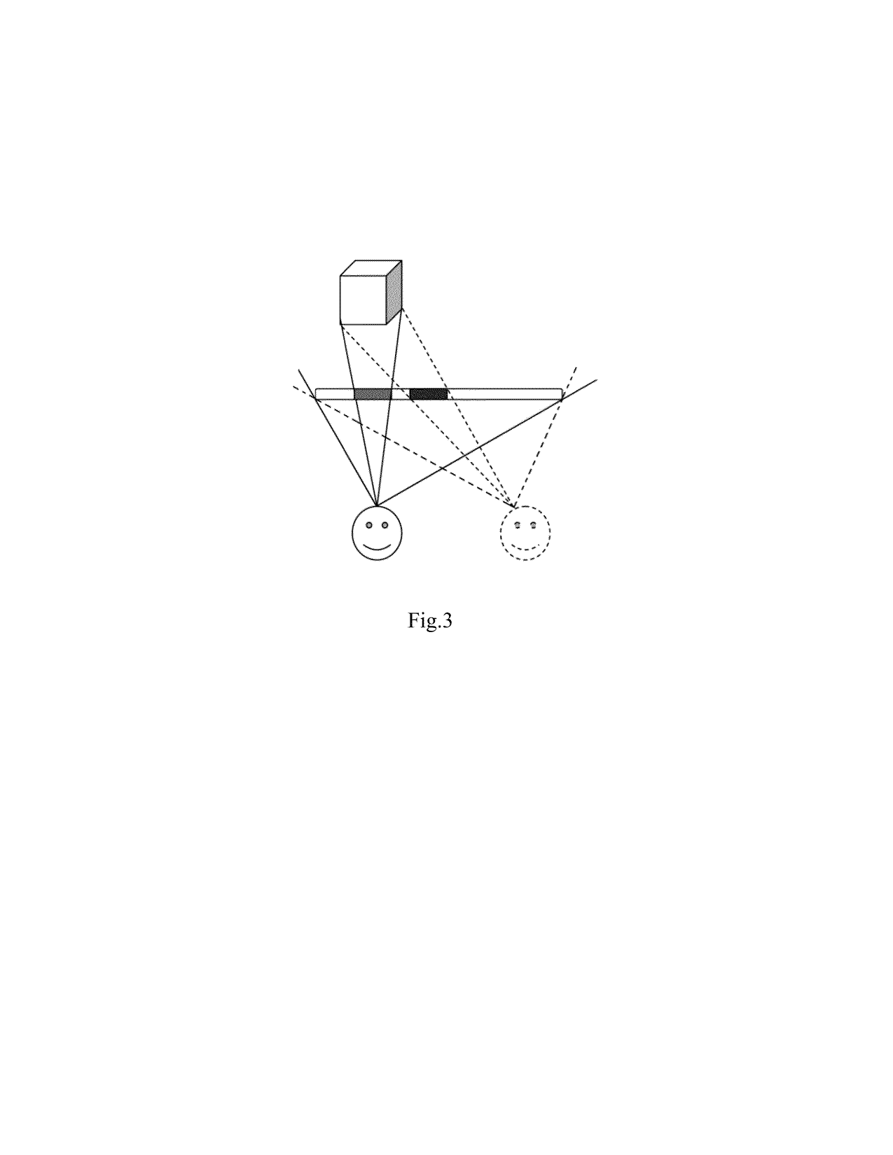

The information processing device 2 according to the embodiment of the present invention is described above. However, the present invention is not limited thereto. Since the user does not always hold the information processing device 2 in a fixed manner, and the user's head does not necessarily correspond to the center of the display screen 21, the display position of the additional information may be inaccurate. FIG. 3 shows the change of the display position of the additional information required to be superimposed due to the different positions of the user's head. In this case, according to another embodiment of the present invention, the information processing device 2 can also comprise a camera module provided on the other side of the information processing device 2 (the side facing the user), the camera module is configured to acquire the image of the relative position of the user's head with respect to the display screen.

After the camera module captures the image of the user's head, the additional information position determining unit 24 can determine the relative position of the user's head and the display screen 21 by performing face recognition on the user's head image acquired by the camera module. For example, since the pupillary distance and nose length of the user's head is relatively fixed, it is possible to obtain a triangle and the size of the triangle through the pupillary distance and nose length in the head image captured when the user's head is directly facing the display screen 21 and there is a predetermined distance (e.g., 50 cm) between the user's head and the display screen. When the user's head is offset from the central region of the display screen 21, the triangle formed by the pupillary distance and the nose length deforms and the size thereof changes. In this case, by calculating the perspective relationship and the size of the triangle, the relative position between the head of the user and the display screen 21 can be acquired. Here, the relative position includes the projection distance between the user's head and the display screen 21 and the relative position relationship (e.g., the projection of the user's head on the display screen offsets 5 cm on the left of the central region 21 etc.). Since the above-described face recognition technology is well known for those skilled in the art, the detailed description of the specific calculation process is omitted. In addition, as long as it is possible to acquire the projection distance between the user's head and the display screen 21 and the relative position relationship thereof, other well known face recognition technologies can also be used.

After the distance between the user's head and the display screen 21 and the relative position relationship thereof are acquired, the additional information position determining unit 24 corrects the visual range of the scene seen by the user through the display screen 21 determined by the object determining unit 22. For example, according to one embodiment of the present invention, the additional information determining unit 24 can easily acquire the lengths from the user's head to the four sides or the four vertices of the display screen 21 through the projection distance between the acquired user's head and the display screen 21 and the relative position relationship thereof, and can acquire the angle (viewing angle) of the scene seen by the user through the display screen 21, for example, through the ratio of the projection distance to the acquired length, so as to re-determine the visual range of the scene seen by the user through the display screen 21 based on the relative position of the user's head and the display screen. In addition, the additional information determining unit 24 sends the corrected visual range to the object determining unit 22 so as to determine the object in the visual range.

Then, similar to the description of FIG. 2, after the object determining unit 22 determines the object within the visual range of the user, the additional information acquisition unit 23 acquires the additional information corresponding to the determined object from the map data stored in the storage device (not shown) of the information processing device 2 or the map data stored in the map server connected with the information processing device 2. Then, the object position acquisition module 241 of the additional information position determining unit 24 acquires the position of the object. In this case, the additional information position determining unit 24 determines (corrects) the display position of the additional information on the display screen 21 based on the re-determined visual range and the position of the object. Here, since the process during which the additional information position determining unit 24 determines (corrects) the display position of the additional information on the display screen 21 based on the re-determined visual range and the object position is similar to the description of FIG. 2, for the sake of simplicity of the specification, the repeated description of the process is thus omitted here.

With the above configuration, the information processing device according to the embodiment of the present invention can judge the visual range of the user through the display screen 21 according to the relative position of the user with respect to the screen 21, make adaptive adjustments on the visual range, and adjust display position of the additional information of the object based on the relative position of the user with respect to the screen 21, thereby improving the feeling of the user's experience.

Various embodiments of the present invention are described above. However, the present invention is not limited thereto. The information processing device shown in FIG. 1 or FIG. 2 also can comprise a gesture determining unit. The gesture determining unit is used for acquiring the data corresponding to the gesture of the information processing device, and can be realized by the triaxial accelerometer.

According to the present embodiment, the additional information position determining unit can determine the gesture of the information processing device (i.e., the display screen) based on the data corresponding to the gesture of the information processing device and the determining process is the content well known by those skilled in the art (the detailed description is omitted). After the gesture of the information processing device is acquired, the additional information position determining unit can be corrected the display position of the additional information on the display screen based on the gesture of the information processing device. For example, when the user holds the information processing device upwardly to view the scene, the additional information position determining unit can determine the gesture of the information processing device (e.g., the information processing device has an elevation angle of 15 degrees) based on the gesture data acquired by the gesture determining unit. In this case, since the information processing device has an elevation angle, the position of the object seen by the user through the display screen 21 is lower than the position of the object seen horizontally by the user through the display screen 21, so the additional information position determining unit can move the determined display position downwards a certain distance. Furthermore, when the information processing device has a depression angle, the additional information position determining unit can move the determined display position upwards a certain distance. The extent of the upward/downward movement of the display position by the additional information position determining unit corresponds to the gesture of the information processing device, and related data can be acquired by experiments or tests.

Further, according to another embodiment of the present invention, the information processing device can also comprise a touch sensor provided on the display screen, and the additional information can be rendered in the form of the cursor. In this case, the cursor is displayed in the display position corresponding to the object on the display screen 21, and when the user touches the cursor, the information processing device displays the additional information in the display position corresponding to the object based on the user's touch.

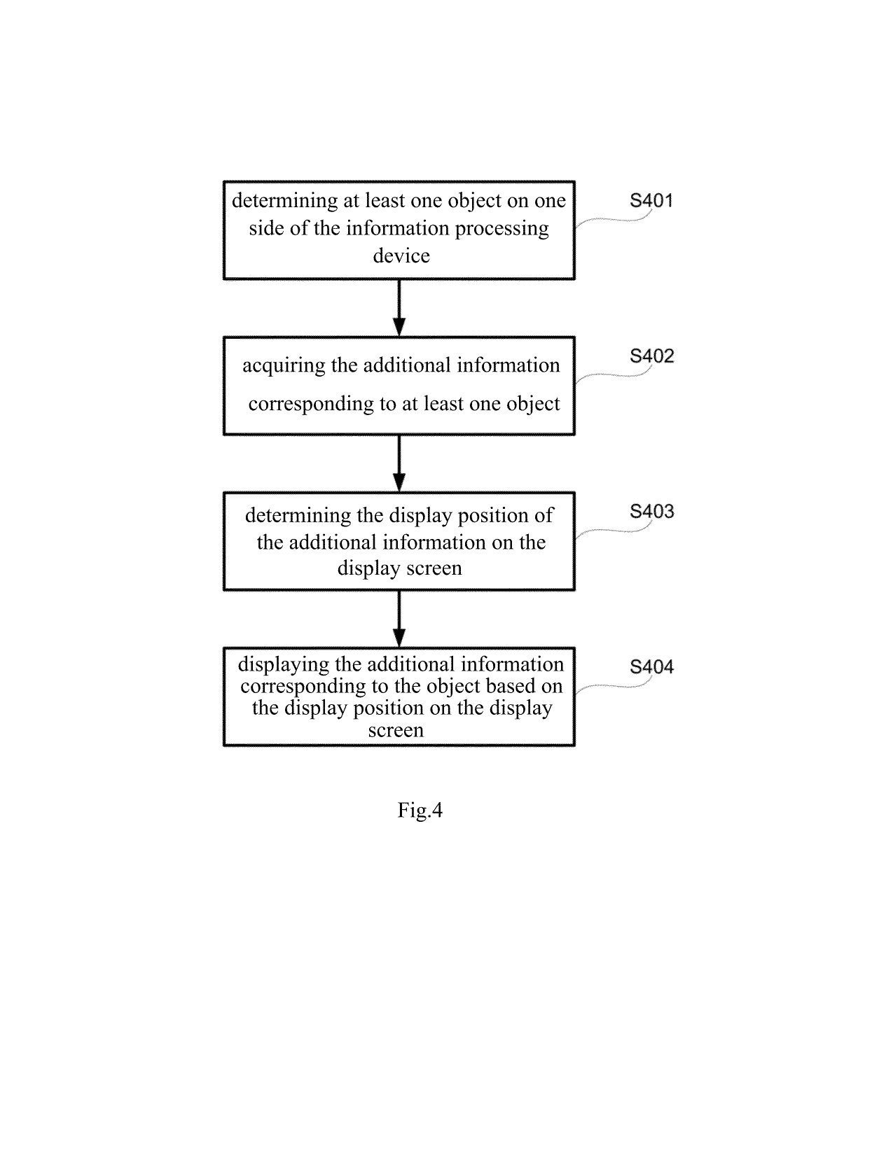

Next, the information processing method according to an embodiment of the present invention will be described, which is applied to the information processing device according to an embodiment of the present invention. FIG. 4 is a flowchart illustrating the information processing method according to an embodiment of the present invention.

As shown in FIG. 4, at step S401, at least one object on one side of the information processing device is determined.

Specifically, according to one embodiment of the present invention, similar to the description for FIG. 1, the camera module 121 of the object determining unit 12 captures the object on one side of the information processing device 1 (i.e., the side towards the object).

In addition, according to another embodiment of the present invention, similar to the description for FIG. 2, the positioning module 221 of the object determining unit 22 acquires the current position data of the information processing device 2. The direction detecting module 222 acquires the orientation data of the information processing device 2. The object determining module 223 determines where the information processing device 2 (user) is and which direction the user is looking towards based on the current position data and the orientation data of the information processing device 2. Further, after the position and orientation of the information processing device 2 is determined, the visual range (i.e., viewing angle) of the scene (such as buildings, landscapes, etc.) seen by the user through the display screen 21 of the information processing device 2 can be determined by using trigonometric functions based on the distance from the user's head to the display screen 21 and the size of the display screen 21. Then the object determining module 223 can determine at least one object within the visual range based on a predetermined condition. Here, for example, the predetermined condition can be an object within one kilometer to the information processing device 2, or an object of a certain type in the visual range (e.g., a building) etc.

At step S402, the additional information corresponding to at least one object is acquired.

Specifically, according to one embodiment of the present invention, similar to the description for FIG. 1, the additional information acquiring unit 13 judges the object by performing image recognition on the object in the image captured by the camera module 121 and generate additional information related to the class of the object. In addition, the additional information acquisition unit 13 can also judge the object (e.g., a mouse, etc.) having the electronic label to judge the object, and generates the additional information corresponding to the object.

In addition, according to another embodiment of the present invention, similar to the description for FIG. 2, the additional information acquisition unit 23 acquires the additional information corresponding to the determined object from the map data stored in the storage device (not shown) of the information processing device 2 or the map data stored in the map server connected with the information processing device 2, based on the object determined by the object determining unit 22.

At step S403, the display position of the additional information on the display screen is determined.

Specifically, according to an embodiment of the present invention, similar to the description for FIG. 1, the additional information position determining unit 14 determines the display position on the display screen 11 of the additional information corresponding to objects based on the object position in the image captured by the camera module 121. For example, the focal length of the camera module 121 can be suitably selected, so that the image acquired by the camera module 121 is basically consistent with the scene (angle) of the real scene seen by the user through the display screen 11, that is, the images captured by the camera module 121 is substantially identical with the real scene seen by the user through the display screen 11. In this case, the additional information position determining unit 14 can determine the display position of the additional information corresponding to the object based on the object position in the images captured by the camera module 121. Further, the additional information position determining unit 14 can also correct the display position of the additional information based on the position relationship of the camera module 121 and the display screen 11.

In addition, according to another embodiment of the present invention, similar to the description for FIG. 2, the additional information position determining unit 24 determines the distance from the object to the information processing device 2 (user) and the angle between the object and the orientation of the information processing device 2. After the distance between the object and the information processing device 2 (user) and the angle between the object and the orientation of the information processing device 2 are determined, the additional information position determining unit 24 can calculate the projection distance from the object to the plane where the display screen 21 of the information processing device 21 is by using the above information. Then the additional information position determining unit 24 uses the data of current position and orientation of the information processing device 2, the projection distance from the object to the information processing device 2 (the display screen 21) and the visual range (viewing angle) previously obtained to construct a virtual plane (the position of the object is in the constructed virtual plane). Since a virtual plane is constructed through the projection distance from the object to the information processing device 2 (the display screen 21) and, as described above, the object is the object determined in the visual range, the position of the object is in the virtual plane constructed by the additional information position determining unit 24. After constructing the virtual plane, the additional information position determining unit 24 determines the position of the object in the virtual plane constructed for the object. For example, the position of the object in the virtual plane can be determined through the distance from the object to the four vertices of the virtual plane. In addition, the position of the object in the virtual plane can also be determined through the distance from the object to the four sides of the virtual plane. Then the additional information position determining unit 24 can determine the display position of the additional information on the display screen 21 based on the position of the object in the virtual plane.

At step S404, the additional information corresponding to the object is displayed based on the display position.

Specifically, according to one embodiment of the present invention, and similar to the description for FIG. 1, the display processing unit 15 displays the additional information corresponding to the object in the position on the display screen 11 based on the display position of the additional information determined by the additional information position determining unit 14.

In addition, according to another embodiment of the present invention, similar to the description for FIG. 2, the display processing unit 25 displays the additional information of the object in the position corresponding to the object on the display screen 21 based on the display position of the additional information determined by the additional information position determining unit 24.

The information processing method according to an embodiment of the present invention is described above. However, the present invention is not limited thereto. For example, according to another embodiment of the present invention, the information processing method shown in FIG. 4 can further comprise the steps of: acquiring the data corresponding to the relative position of the user's head with respect to the display screen, and based on the relative position of the user's head and the display screen, the display position of the additional information on the display screen is corrected.

Specifically, similar to the previous description, the image data of the user's head is captured by providing the camera module on the side towards the user. The additional information position determining unit 24 judges the relative position of the user's head and the display screen 21 by performing face recognition on the acquired image of the user's head. Then, the additional information position determining unit 24 corrects the visual range of the screen seen by the user through the display screen determined by the object determining unit 22 based on the relative position of the user's head with respect to the display screen 21. After the object determining unit 22 determines the object within the visual range of the user based on the corrected object range (visual range), the additional information acquisition unit 23 acquires additional information corresponding to the determined object. Then, the additional information position determining unit 24 acquires the position of the object, and the display position of the additional information on the display screen 21 can be determined (corrected) based on the re-determined visual range and the position of the object.

Further, according to another embodiment of the present invention, the information processing method shown in FIG. 4 may further comprises the steps of: acquiring the data corresponding to the gesture of the information processing device, and correcting the display position of the additional information in the screen based on the data corresponding to the gesture of the information processing device.

Specifically, the gesture determining unit acquires the data corresponding to the gesture of the information processing device. The additional information position determining unit can determine the gesture of the information processing device (i.e., the display screen) based on the data corresponding to the gesture of the information processing device. Then the additional information position determining unit can correct the display position of the additional information on the display screen based on the gesture of the information processing device. For example, when the user holds the information processing device upwardly viewing the scene, the additional information position determining unit can determine the gesture of the information processing device (e.g., the information processing device has an elevation angle of 15 degrees) based on the gesture data acquired by the gesture determining unit. In this case, since the information processing device has an elevation angle, the position of the object seen by the user through the display screen 21 is lower than the position of the object seen horizontally by the user through the display screen 21, so the additional information position determining unit can move the determined display position downwards a certain distance. Furthermore, when the information processing device has a depression angle, the additional information position determining unit can move the determined display position upwards a certain distance. The extent of the upward/downward movement of the display position by the additional information position determining unit corresponds to the gesture of the information processing device, and related data can be acquired by experiments or tests.

The information processing method shown in FIG. 4 is described in a sequential manner above. However, the present invention is not limited thereto. As long as the desired result can be acquired, the above processing can be performed in the order different from the sequence described above (e.g., exchanging the order of some steps). Moreover, some of the steps can also be performed in a parallel manner.

A plurality of embodiments of the present invention has been described above. However, it should be noted that the embodiment of the present invention can be implemented by using entire hardware, entire software or the combination of hardware and software. In some embodiments, it is possible to implement the above-mentioned functional components by any central processor, microprocessor or DSP, etc. based on a predetermined program or software, and the predetermined program or software includes (but not limited to) firmware, built-in software, micro-code, etc. For example, the data processing function of the object determining unit, additional information acquiring unit, additional information position determining unit, and display processing unit can be implemented by any central processor, a microprocessor or DSP, etc. based on a predetermined program or software. Further, the present invention can be in the form of a computer program product of the processing method according to the embodiment of the present invention used by a computer or any command execution system, and the computer program product is stored in on the computer readable medium. Examples of the computer readable medium include the semiconductor or solid state memory, magnetic tape, removable computer diskette, random access memory (RAM), read-only memory (ROM), the hard disk, CD-ROM etc.

As described above, various embodiments of the present invention have been specifically described, but the present invention is not limited thereto. It should be understood by those skilled in the art that various modifications, combinations, sub-combinations, or replacements can be carried out according to the design requirements, or other factors, which are within the scope of the appended claims and their equivalents.

What is claimed is:

1. An information processing device, comprising:
a display unit having a predetermined transmittance;
an object determining unit, configured to determine at least one object on one side of the information processing device;
an additional information acquisition unit, configured to acquire the additional information corresponding to the at least one object;
an additional information position determining unit, configured to determine the display position of the additional information on the display unit; and
a display processing unit, configured to display the additional information on the display unit based on the display position.

2. The information processing device according to claim 1, wherein
the object determining unit comprises a first image acquisition module, configured to capture a first image comprising the at least one object; and
the additional information position determining unit determines the display position of the additional information on the display unit based on the position of the at least one object in the first image.

3. The information processing device according to claim 2, wherein
the additional information acquisition unit further comprises at least one of an image recognition unit and an electronic label recognition unit, wherein
the image recognition unit is configured to recognize the at least one object in the first image to generate the additional information related to the at least one object; and
the electronic label recognition unit is configured to recognize the object having the electronic label to generate the additional information corresponding to the electronic label.

4. The information processing device according to claim 1, wherein
the object determining unit comprises:
a positioning module, configured to acquire the current position data of the information processing device;
a direction detecting module, configured to acquire the orientation data of the information processing device; and
an object determining module, configured to determine the object range comprising the at least one object based on the current position data and the orientation data, and determine at least one object satisfying a predetermined condition within the object range, and
the additional information position determining unit further comprises:
an object position acquisition module, configured to acquire the position data corresponding to the at least one object,
wherein the additional information position determining unit determines the display position of the additional information on the display unit based on the object range and the position data corresponding to the at least one object.

5. The information processing device according to claim 4, wherein
the object position acquisition module comprises at least one of a three-dimensional image acquisition module, a distance acquisition module and a geography position information acquisition module.

6. The information processing device according to claim 1, further comprising:
a second image acquisition module, provided on the other side of the information processing device, configured to acquire the relative position image of the users' head with respect to the display unit,
wherein the additional information position determining unit corrects the display position of the additional information on the display unit based on the relative position of the users' head with respect to the display unit.

7. The information processing device according to claim 4, further comprising:
a gesture determining unit, configured to acquire the data corresponding to the gesture of the information processing device,
wherein the additional information acquisition unit determines the gesture of the information processing device based on the data corresponding to the gesture of the information processing device and corrects the display position of the additional information on the display unit based on the gesture data.

8. An information processing method applied to an information processing device, the information processing device comprising a display unit having a predetermined transmittance, the information processing method comprising:
determining at least one object on one side of the information processing device;
acquiring the additional information corresponding to the at least one object;
determining the display position of the additional information on the display unit;
displaying the additional information on the display unit based on the display position.

9. The information processing method according to claim 8, wherein
the step of determining the at least one object comprises:
determining the at least one object by acquiring a first image of the at least one object; and
the step of determining the display position of the additional information further comprises:
determining the display position of the additional information on the display screen based on the position of at least one object in the first image.

10. The information processing method according to claim 9, wherein:
judging the object by recognizing the image or the electronic label on the at least one object, and acquiring the additional information corresponding to the at least one object.

11. The information processing method according to claim 8, wherein
the step of determining at least one object further comprises:
acquiring the current position data of the information processing device;
acquiring the orientation data of the information processing device; and
determining the object range of the at least one object based on the current position data and the orientation data, and determining the at least one object in the object range satisfying a predetermined condition, and
the step of determining the display position of the additional information further comprises;
acquiring the position data corresponding to the at least one object, and
determining the display position of the additional information on the display unit based on the object range and the position data corresponding to the at least one object.

12. The information processing method according to claim 8, further comprising:
acquiring the data corresponding to the relative position of the user's head with respect to the display unit, and
correcting the display position of the additional information on the display unit based on the relative position of the user's head with respect to the display unit.

13. The information processing method according to claim 1 further comprising:
acquiring the data corresponding to the gesture of the information processing device, and
correcting the display position of the additional information on the display unit based on the data corresponding to the gesture of the information processing device.
